(19) United States
(12) Patent Application Publication
(10) Pub. No.: US 2020/0385119 A1
(43) Pub. Date: Dec. 10, 2020

(54) ELEMENT FOR A WINDOW, DOOR, PITCHED ROOF OR FACADE, COMPRISING A DEVICE FOR SENDING OR RECEIVING LETTERS AND PARCELS FROM AN UNMANNED AIR VEHICLE

(71) Applicant: SCHÜCO INTERNATIONAL KG, Bielefeld (DE)

(72) Inventor: Carsten HANKE, Bielefeld (DE)

(21) Appl. No.: 16/971,475

(22) PCT Filed: Feb. 21, 2018
(86) PCT No.: PCT/EP2018/054206

§ 371 Date: Aug. 20, 2020

(51) Int. Cl. B64C 39/02; E06B 3/26

(52) U.S. Cl. CPC B64C 39/024; E06B 3/2605; E06B 2003/2615; B64C 2201/027; E05Y 2900/148; B64C 2201/042; E05Y 2800/122; B64C 2201/128

(57) ABSTRACT

An element for a window, door, pitched roof, or façade for installation in a building opening of a wall, a façade, or a pitched roof, includes a device for sending or receiving letters and parcels. The device is designed such that the letters and parcels can be picked up or delivered by an unmanned air vehicle. The element for a window, door, pitched roof, or façade includes an outer leaf and an inner leaf, which are separated from one another by an intermediate space.

### BACKGROUND AND SUMMARY OF THE INVENTION

Exemplary embodiments of the invention relate to an element for a window, door, pitched roof, or façade for installation in a building opening of a wall, a façade, or a pitched roof, having a device for sending or receiving letters and parcels, wherein the device is designed so that the letters or parcels can be retrieved or delivered by an unmanned air vehicle. This device is also referred to synonymously hereafter as a “device for sending or receiving letters and parcels using an unmanned air vehicle”. Letters and parcels are also referred to in brief hereafter as mail items.

The term “drone” is used hereafter. A drone is to be understood in the claims and the description of the present invention as an unmanned air vehicle/aircraft, which, without crew located on board, can be operated and navigated autonomously by an onboard computer or from the ground via a remote control. The unmanned air vehicle in terms of the present invention is preferably designed as a vertical takeoff and landing unmanned air vehicle. A construction to be encountered frequently—but not exclusively—of such an air vehicle is the so-called quadrocopter. A quadrocopter is an air vehicle which uses four rotors or propellers arranged in a plane and acting vertically downward to generate lift and, by inclination of the rotor plane, also propulsion.

Drones are also supposed to be used for sending or receiving letters and parcels. Compared to a road-based mail item delivery, drone delivery is expected to be accompanied by a reduction of the road traffic, a time acceleration of the delivery process, a reduction of the pollutant load, and overall a significant cost reduction. Locations that are difficult or cumbersome to reach using conventional means can moreover be served more easily and quickly.

Various structural designs having a device for sending or receiving letters and parcels have already been proposed in recent years, but they have various disadvantages.

Thus, a type of receiving station for delivery by unmanned aircraft on a roof is provided in DE 10 2015 209 127 A1, which comprises both a motorized closure and also a lifting device (telescopic device). When not in use, the closure is aligned flush with the roof, while it is opened for use to extend the lifting device in order to receive a packet using it. In particular, the visual negative effect on the building envelope by the disclosed solutions is disadvantageous. The separate device clearly stands out visually from the building, even if only a cover arranged flush is visible of the device. In addition, the device according to DE 10 2015 209 127 A1 cannot be arranged in a vertical building wall.

WO 2017/125084 A1, in contrast, describes an unmanned air vehicle express system, based on a controllable window. It comprises a leaf, which is movably fitted on the base of the window—i.e., by way of a horizontal axis of rotation. When the leaf is open, it forms a horizontal platform, on which the unmanned air vehicle can park.

However, the devices are only imperfectly suitable for sending and receiving mail items, since they are not optimally suitable for landings and takeoffs due to the mechanisms used.

Moreover, thermal insulation problems have to be dealt with in WO 2017/125084 A1 and according to the technical teaching of DE 10 2015 209 127 A1, since the described solutions do not have special insulation properties and therefore represent a cold bridge in a thermally-insulated building envelope.

Exemplary embodiments of the invention are directed to an element for a window, door, pitched roof, or façade having a device for sending or receiving letters and parcels by way of unmanned air vehicles, which improves the mentioned disadvantages, i.e., represents a visual improvement and in particular meets increased thermal-insulation demands on modern buildings or building envelopes.

According to an embodiment, there is an element for a window, door, pitched roof, or façade for installation in a building opening of a wall, a façade, or a pitched roof, having a device for sending or receiving letters and parcels, wherein the device is designed such that the letters or parcels can be retrieved or delivered by an unmanned air vehicle, wherein the element for a window, door, pitched roof, or façade comprises a movable outer leaf and a movable inner leaf, which are separated from one another by an intermediate space.

Improved thermal insulation can be achieved at the element in a simple manner in this way, in particular if outer leaf and inner leaf are controlled using a control device so that they can only be opened or closed offset in time. This is advantageous, but not absolutely necessary. A certain ventilation effect can possible also be achieved on a building using the airlock, which be entirely desirable, for example, to enable a certain ventilation by briefly opening both leaves by a certain gap.

The intermediate space is preferably circumferentially delimited on its circumference by at least one fixed frame. However, it can also be circumferentially delimited by a masonry wall or the like.

The elements according to the invention for a window, door, pitched roof, or façade or the like can also be used in openings of arbitrary housings, for example, in letter and parcel receiving stations or containers. The elements are designed here such that they are usable for receiving letters and parcels by way of drones. The elements are preferably designed such that they withstand weather influences, e.g., wind, moisture, temperature differences, etc. toward the building interior to an increased extent up to the passive house standard and thus accordingly have good insulation and sealing properties.

According to one advantageous variant, the intermediate space accommodates the device in the closed state of the element for a window, door, pitched roof, or façade. In this way, the device is housed well protected if no mail items are to be received or sent. Moreover, the appearance of the building is not negatively affected by the device on the outside or on the inside.

A pitched roof is a roof having an angle of inclination between 10° and 80° to the horizontal.

It can also be provided here according to a further expedient variant that the intermediate space is designed in the closed state for accommodating or temporarily storing the letters or parcels.

It can advantageously be provided that the device for receiving and sending letters or parcels comprises a landing region for landing of the aircraft for the letters or parcels. However, it at least comprises a receptacle region for receiving or picking up the letters or parcels.

It is advantageous from a design and appearance aspect if the outer leaf and the inner leaf are aligned in parallel to one another at least in the closed state.

It can advantageously be provided from a kinematic aspect that the outer leaf rotates or is pivotable outward around a horizontal axis in an opening movement. This is because in this way a horizontal position can be achieved easily, which is advantageous to accept or send the mail item at the pickup region. Moreover, the landing region can also be formed simply in this manner, if such a region is to be provided.

In contrast, the inner leaf can be designed so that it rotates or can be extended in parallel around a vertical axis or horizontal axis in an opening movement. In this way, the removal and/or the introduction of the mail item from the interior is possible in a simple manner, without thermal insulation having to be dispensed with due to an airlock between inside and outside.

It is advantageous according to one refinement if the device for receiving and sending parcels using an unmanned aircraft comprises a thrust device and/or pivot device associated with the outer leaf, using which the landing region and/or the receptacle element for the letters or parcels can be moved telescopically into a position spaced apart farther from the plane of the window, door, pitched roof, or façade than is directly achievable on the outer leaf. This is because this facilitates the landing and takeoff of the aircraft.

According to another advantageous variant, the outer leaf comprises a sash and a planar element and/or the inner leaf comprises a sash and a planar element and/or one or more frames are provided, on which the inner leaf and the outer leaf are movably mounted.

Moreover, one, multiple, or all of the frames and sashes can be embodied in a thermally-insulated embodiment, in particular in such a way that if metal is used, in particular aluminum, a multilayered structure having one or multiple metal profiles, in particular aluminum profiles, and at least one insulating profile plane arranged in between, made of insulating profiles made of plastic, is provided from the inside to the outside on the respective frame.

According to one variant of the invention, which can also be considered to be an independent invention, however, an element for a window, door, pitched roof, or façade for installation in a building opening of a wall, a façade, or a pitched roof is provided, in which the element for a window, door, pitched roof, or façade comprises at least one leaf—an outer leaf for closing and opening a building opening—wherein a thrust device is associated with this outer leaf, using which a landing region and/or a pickup element for the letters or parcels can be moved telescopically farther out of the building plane (or outer leaf plane in the closed state) in the extended state or into a position spaced apart from the plane of the window, door, pitched roof, or façade than in the retracted state, wherein the thrust direction of the thrust device extends in parallel to the outer leaf or the leaf plane. In this way, the thrust device can be housed particularly compactly on the leaf and can be implemented using simple means. Moreover, this facilitates the landing and takeoff of the aircraft and/or the setting down and picking up of the mail item. An inner leaf can optionally be provided, but is not absolutely necessary for implementing this invention or this variant of the invention.

According to one refinement of this variant of the invention, it can advantageously be provided that the outer leaf is pivotable into a horizontal position and lockable in this position, and the thrust device extends in the horizontal. This is because only little force and energy are required for extending and retracting the thrust device in the present case.

For example, solely a telescopic rail guide having multiple telescoping rails between the landing region and/or the receptacle element and the outer leaf can then be provided as the thrust device.

Moreover, it can advantageously be provided that the thrust device comprises a drive, in particular an electromotive drive.

According to a further variant of the invention, which can also be considered to be an independent invention, a façade for a building is provided, having a plurality of façade elements, of which a part is or are formed without a device for receiving and sending parcels using an unmanned aircraft, and wherein at least one of the façade elements is provided with a device for receiving and sending parcels using an unmanned aircraft, wherein the appearance of the various façade elements with and without device for sending and receiving parcels using an unmanned aircraft is identical or essentially identical observed from the outside. In this way, the appearance of the façade is not negatively affected by the façade element suitable for receiving and sending mail items. This variant of the invention is suitable in particular, but not only, for element façades which are formed from prefinished façade elements arranged in columns and rows on a building outer wall. In particular, it is provided that the various façade elements each comprise an identical outer plate of identical dimensions and possibly surface composition for this purpose, which is externally visible and possibly—if provided—a sash appearing identical from the outside.

The invention also implements a use of an element for a window, door, pitched roof, or façade for installation in a building opening of a wall, a façade, or a pitched roof, having a device for sending or receiving letters and parcels, wherein the device is designed such that the letters or parcels can be picked up or delivered by an unmanned air vehicle, and wherein the element for a window, door, pitched roof, or façade comprises an outer leaf and inner leaf which are separated from one another by an intermediate space, as a receiving and/or sending station for the letters and parcels.

### BRIEF DESCRIPTION OF THE DRAWING FIGURES

The invention is explained in greater detail hereafter with reference to the drawing on the basis of exemplary embodiments, wherein further advantages of the invention will also become clear. It is to be emphasized that the exemplary embodiments discussed hereafter are not supposed to describe the invention exhaustively, but rather variants and equivalents which are not shown are also implementable and fall under the claims. In the figures:

FIG. 1: shows a three-dimensional view of a building having an element for a window, door, pitched roof, or façade according to the invention, which is approached by a drone in flight;

FIG. 2: shows a three-dimensional illustration of a façade detail of the building from FIG. 1 having a façade element according to the invention in the closed state;

FIG. 3: shows a three-dimensional illustration of the façade detail from FIG. 2 having a façade element according to the invention in the open state;

FIG. 4: shows a three-dimensional illustration of the façade detail from FIG. 2 having an embodiment variant of the façade element from FIG. 3 with a landing drone;

FIG. 5: shows the embodiment variant of the façade element from FIG. 4, in which the deposited shipment is conveyed by the device in the direction of the building interior;

FIG. 6: shows a side view of an element for a window or façade according to the invention for vertical installation in a building wall;

FIG. 7: shows a side view of a pitched roof element according to the invention for inclined installation in the building—for example, in a pitched roof surface inclined obliquely to the horizontal;

FIG. 8: shows a side view of an embodiment variant of the pitched roof window element from FIG. 7 having open leaf;

FIG. 9: shows a side view of the pitched roof window element from FIG. 8 having closed leaf;

FIG. 10: shows an embodiment variant of a façade element according to the invention similar to FIG. 4;

FIG. 11: shows a further embodiment variant of a façade element according to the invention similar to FIG. 4;

FIG. 12: shows a sectional illustration of a portion of a variant of a window element according to the invention;

FIG. 13: shows a sectional illustration of a portion of another variant of a window element according to the invention from FIG. 12;

FIG. 14: shows a three-dimensional view of a further variant of a window element according to the invention for installation in a building opening having a cranked-open inner leaf;

FIG. 15: shows a side view of the window element from FIG. 14 having a cranked-open inner leaf and a pivoted-open outer leaf;

FIG. 16: shows a three-dimensional view of a further window element according to the invention for installation in a building opening having a cranked-open inner leaf;

FIG. 17: shows a side view of the window element from FIG. 16 in a different open state having a cranked-open inner leaf and a pivoted-open outer leaf;

FIG. 18: shows a three-dimensional view of the window element according to the invention from FIG. 17 having a pivoted-open outer leaf having a telescopically extendable landing platform on the pivoted-open outer leaf;

FIG. 19: shows a front view of the window element from FIG. 18 having open inner leaf and closed outer leaf;

FIG. 20: shows a three-dimensional view of an arrangement of a window element according to the invention, for example, similar to FIG. 16 in a portion of a façade.

### DETAILED DESCRIPTION

Terms such as “top”, “bottom”, “right”, “left”, “inside”, or “outside” refer to the respective illustrated position in the figures and are to be understood or viewed relatively in the case of movements—in particular rotations—of the illustrated elements in space.

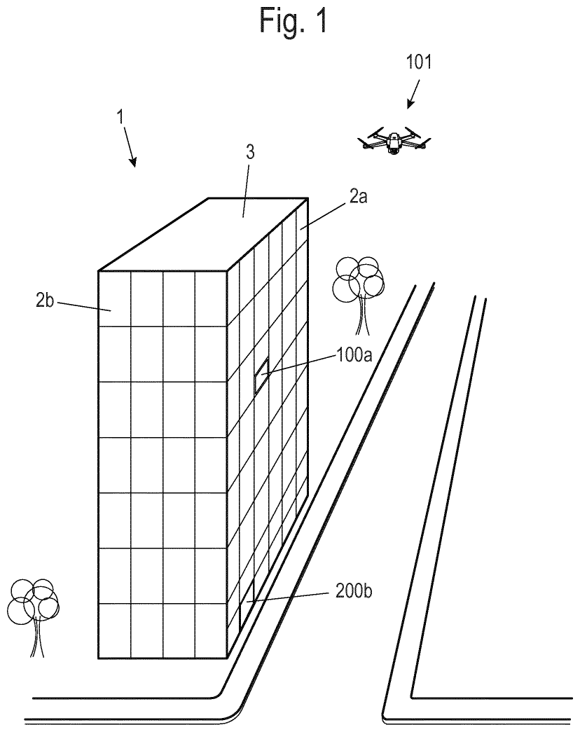

A building 1 is illustrated in FIG. 1. The building 1 has a rectangular outline here.

The building 1 comprises, by way of example here, six stories plus the ground floor. The building 1 can also comprise greater or fewer stories. The building 1 comprises a roof, which is embodied here by way of example as a flat roof. The building 1 can also comprise a pitched roof 3 having inclined pitched roof surfaces, for example, a saddle roof or shed roof.

The building 1 can also have a different geometric outline. The façades of the building visible in FIG. 1 are each embodied as element façades here. They thus consist of a plurality of façade elements 2a, 2b. These are embodied as rectangular here and are arranged in rows one over another and in columns adjacent to one another.

A part of the façade elements 2a, 2b can comprise at least one plate on their outside. This plate can in turn be formed as a glass plate, for example, as an insulating glass plate, in a part or all of the façade elements 2a, 2b.

At least one or more—two of the façade elements here 100a, 200b—each comprise a device (not shown here) for sending or receiving letters and parcels, wherein the device is designed such that the letters or parcels can be picked up or delivered by an unmanned air vehicle (in short “device for receiving and sending mail items using an unmanned aircraft”).

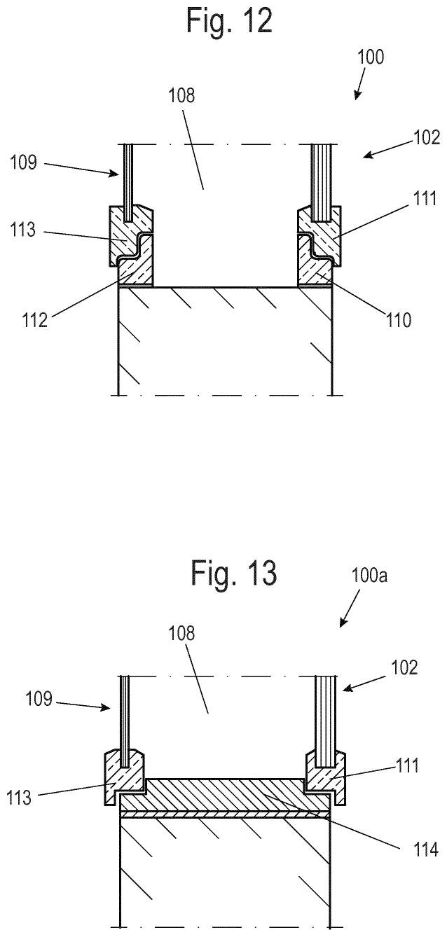

These façade elements are preferably equipped for this purpose with an outer leaf 102 pivotable around a horizontal tilt axis and an openable inner leaf. An exemplary structure is explained hereinafter with reference to FIGS. 12 et seq.

The façade elements 100a, 200b are equipped with an openable and closable outer leaf 102, which comprises a “device 103 for receiving and sending parcels using an unmanned aircraft”. These façade elements 100a, 200b can be installed at nearly any point of the façade of the building and replace a façade element otherwise provided at this point without a device for sending or receiving a mail item using an unmanned aircraft, wherein the device is designed such that the mail item can be retrieved or delivered by an unmanned aircraft.

It is provided as a particularly advantageous design that the façade elements without a device for sending and receiving mail items using an unmanned aircraft may not be differentiated or may not be differentiated significantly from the façade elements 100a, 200b having an outer leaf 102 having a device for receiving and sending mail items using an unmanned aircraft.

A façade having multiple façade elements 2a, 2b; 100a, 200b is provided, of which a part of the façade elements 2a, 2b is or are formed without a device for sending and receiving mail items using an unmanned aircraft, and wherein at least one of the façade elements 100a, 200b, is formed having a device for sending and receiving mail items using an unmanned aircraft, wherein the appearance of these various façade elements is identical or essentially identical viewed from the outside.

For this purpose, the pivotable-open outer leaf 102 having the device 103 for receiving and sending mail items using an unmanned aircraft has, for example, the same area dimensions as the other façade elements without a device for receiving and sending mail items using an unmanned aircraft. Moreover, it can advantageously be provided that the pivotable-open outer leaf having a device for receiving and sending mail items using an unmanned aircraft has, for example, the same outer surface plate, which is oriented toward the building exterior, as the other façade elements without a device for receiving and sending mail items using an unmanned aircraft.

Preferably, the façade elements 100a, 200b having the device 103 for receiving and sending mail items using an unmanned aircraft each comprise an openable and closable inner leaf 109 and an openable and closable outer leaf 102, wherein these are preferably designed as pivoting, sliding, or rotating leaves.

However, the design of at least the outer leaf 102 as a pivoting leaf having a horizontally aligned pivot axis is particularly preferred, since such a pivot axis most easily enables a horizontally aligned landing station 104 for the drone 101 and/or a pickup station 106 for depositing and/or picking up of the mail item by a drone 101 to be formed.

From a specific building height, drones 101 can approach the individual elements of windows, doors, or façades in flight without endangering persons located in front of or in the vicinity of the building 1. Elements of windows, doors, or façades—like the second element of a window, door, or façade 200b close to the ground, in contrast, can theoretically also be approached in flight, but—if this is not permitted—at least can be approached, for example, by autonomous vehicles on the ground.

Only the façade element 100a is described in greater detail hereinafter. The façade element 200b close to the ground can be constructed identically thereto.

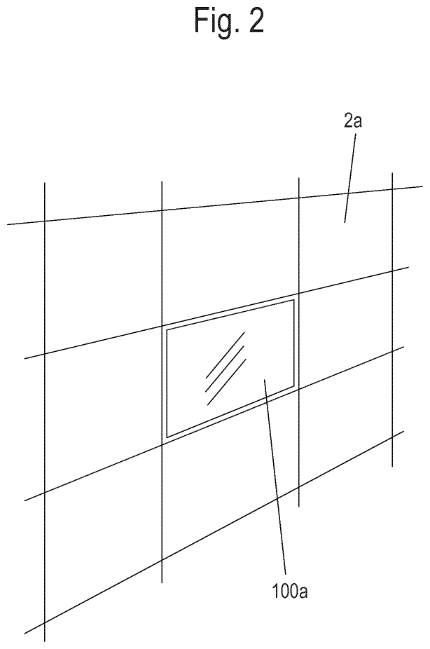

A detail of the façade 2 of the building 1 from FIG. 1 is shown three-dimensionally in FIG. 2. The detail of the façade 2 comprises the façade element 100a having the device for receiving and sending mail items using an unmanned air vehicle. This façade element 100a is arranged here essentially in a plane with the façade outer surface of the building 1 and thus meets extremely high aesthetic requirements. The façade element 100a according to the invention having the device 103 advantageously does not stand out from other elements such as the other façade elements or perhaps even windows or doors of the building 1 without a device 103, and thus has an identical appearance (for example, a glass surface in a glass façade here).

The façade element 100a having the device 103 for receiving and sending mail items using an unmanned aircraft is preferably formed essentially flush with the remaining façade toward the outside and/or toward the inside of the building 1.

The façade element 100a according to the invention having the device 103 for receiving and sending mail items using an unmanned aircraft can form a unit insertable into a building opening alone or can form a part of a higher-order subunit of the façade, which can also include, for example, a window 115 or the like (FIG. 20).

The façade element(s) 100a having the device for receiving and sending mail items using an unmanned aircraft can be arranged at an arbitrary point of the building 1, thus, for example, at individual living units or offices or in stairwells, so that the access by multiple access-authorized persons is possible here.

The outer leaf 102 of the façade element 100a having the device for receiving and sending mail items using an unmanned aircraft is preferably provided with a pivot mechanism for pivoting around a horizontal pivot axis.

The outer leaf 102 of the façade element 100a having the device for receiving and sending mail items using an unmanned aircraft can, according to one advantageous design, comprise a thermally-insulated frame having seals, which accommodates a planar element, for example, a glass plate or glazing.

The outer leaf 102 of the façade element 100a having the device for receiving and sending mail items using an unmanned aircraft can furthermore comprise fitting parts, for example, rotating hinges, stay arms, and locking elements. Such fitting parts are known per se, so that a detailed description is omitted. Reference is made by way of example to the following patent literature at this point: U.S. Pat. Nos. 3,722,142; 2,648,878; EP 3 006 658; EP 1 348 830; EP 1 739 263.

In addition, motorized drives can be used to actuate the outer leaf 102. These include, for example, chain drives or drives which act directly or indirectly on the stay arms. The following opening kinematics are preferably implemented with respect to the element 100a of a window, door, or façade: tilt sash (horizontal axis rotating hinges at the bottom), folding sash (horizontal axis rotating hinges at the top), or lower-fold sash windows (for example, having rotating functions in the stay arms).

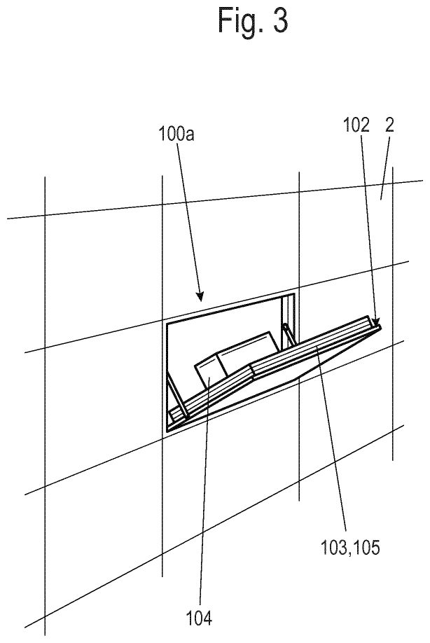

The façade element 100a is shown partially open in FIG. 3.

The façade element 100a of FIG. 3 comprises the device 103 for receiving and sending mail items using an unmanned aircraft on an inner side of the outer leaf 102. This device 103 can be provided with a landing region 104 for a drone 101 (not shown here). The device 103 can also be embodied without the landing region 104. It then instead has to have a deposit and pickup region for the mail items. This can be formed smaller with respect to the area than a landing region but otherwise constructed similarly; in this case the drone 101 would set down the transport material on the outer leaf or throw it thereon from a low height.

For the reliable depositing of the transport material, however, landing of the drone 101 on the landing region 104 of the device 103 is preferred. In addition, landing the drone 101 on the landing region 104 has the advantage that the drone 101 not only can deliver the transport material, but rather can also pick up the transport material particularly easily. The façade element 100a according to the invention is thus not only available for receiving the transport material, but rather also for sending the transport material.

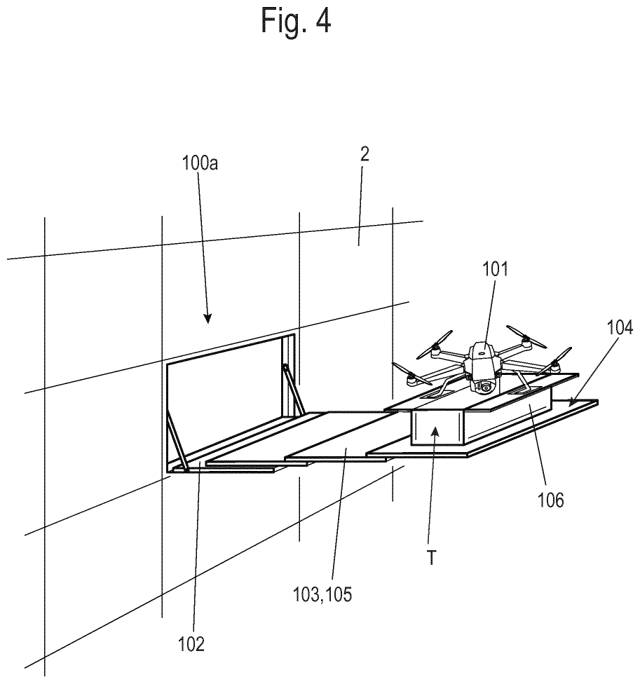

The façade element 100a is shown in a fully open state in FIG. 4. Furthermore, the device 103 for accommodating a transport material T is shown in a maximally open state. The transport material T is presently being delivered or retrieved by a drone 101.

According to one advantageous design, the device 103 can comprise a telescoping thrust device 105, which enables the landing region 104 to be positioned somewhat more spaced apart from the building 1 or spaced apart from the façade 2 than would be possible solely with a pivoting leaf without telescoping thrust device 105.

It can be provided according to one advantageous variant of this design that the thrust direction of the thrust device extends in parallel to the outer leaf 102. This is because, on the one hand, the thrust device can be arranged particularly simply on the pivoting leaf in this way. Moreover, extension and retraction of the thrust device 105 in particular in the horizontal only requires a relatively minor force, so that it is possible to implement an automatically extendable and retractable thrust device using a simple electromotive drive. The drive is not shown here. An optional control device is also not shown, using which the operation of the device 103 or the entire element is controlled in dependence on the flight movements for depositing and retrieving shipments (for example, the folding out and folding in of the outer leaf 102 and the extension and retraction of the thrust device 105).

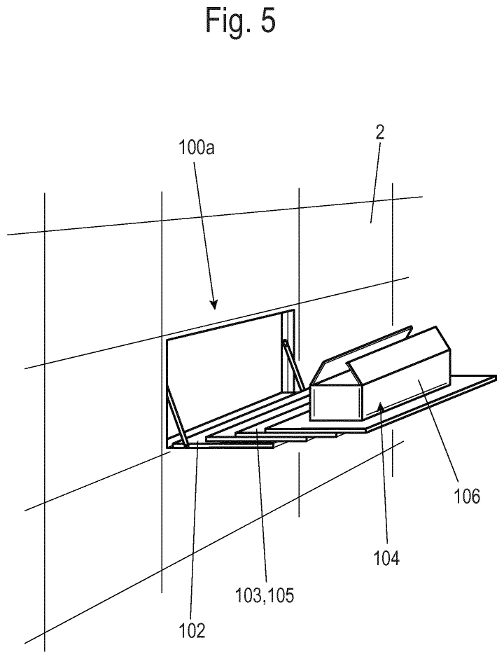

At least one type of telescopic rail guide having multiple telescoping rails (not shown in FIG. 5) can be provided between the thrust device 105 and the outer leaf as the thrust device 105. According to another variant, the thrust device 105 comprises multiple plates telescopically extendable by displacement in relation to one another. The thrust device is implementable in various ways.

In this way, the drone 101 does not have to fly excessively close to the building 1, but rather can maneuver and land safely spaced apart somewhat therefrom. Safe landing and takeoff with reduced risk of collision of the drone 101 with the building 1 is thus ensured. The thrust device 105 can be produced, for example, from additional thermal insulation plates, which can be provided with guides known from the prior art. These can be designed, for example, like drawer guides for items of furniture and are preferably designed to be movable by an electric motor.

The landing region 104 can be formed as a separate, stationary pickup element 106 for the transport material. The pickup element 106 can be formed as a type of shell, as an open box, or as a closable container (see FIG. 3 to FIG. 5). The box can have one or two folding covers, which can be opened or closed by electric motor as needed. The cover surfaces can form additional landing surfaces for the drone 101.

In FIG. 5, the thrust device 105 is shown in a middle position—i.e., between fully extended (see FIG. 4) and fully retracted (see FIG. 3). The receptacle element 106 is shown partially open. The device 103 in FIG. 5 is thus prepared either for a landing approach of the drone 101 (not shown here, see FIG. 4) or the drone 101 has just taken off and the device 103 is prepared for closing the façade element 100.

In another embodiment variant of the invention—which is constructed somewhat more simply but is also less versatile—the façade element 100a comprises a folding leaf as the outer leaf 102, on which the drone 101 can land directly. The outer leaf 102 of the façade element 100a can then comprise an opening permitting the transport material T to be placed directly through the outer leaf 102 into the pickup element 106.

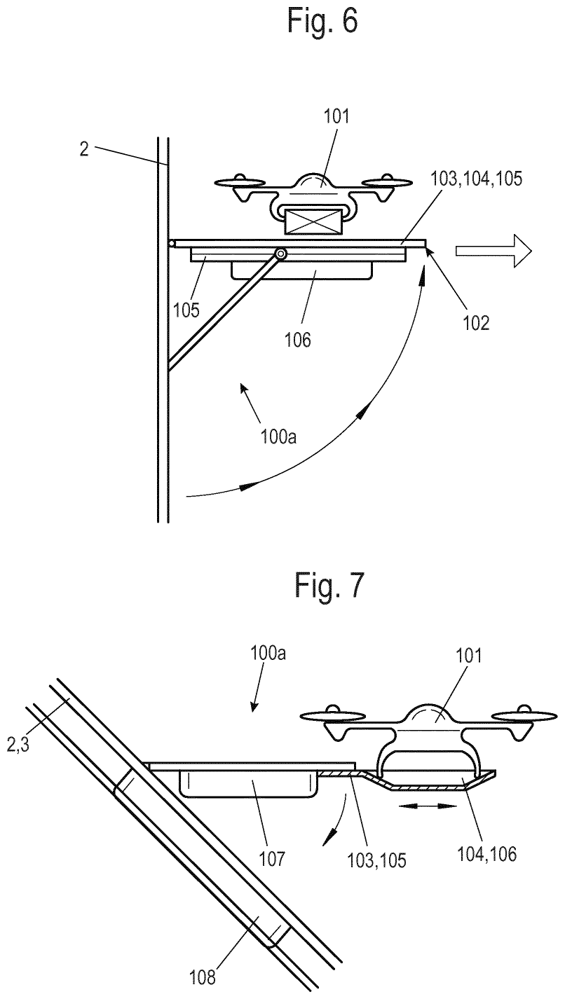

The outer leaf 102 can also have a thrust device 105 having landing region 104 and/or pickup element 106, however. In FIG. 6, the extension is illustrated by the arrow.

FIGS. 7 to 9 show preferred embodiments, wherein a pitched roof window (element) 100 for opening and closing a pitched roof opening of a pitched roof—i.e., in particular a pitched roof having an angle of inclination between 10° and 80° to the horizontal—is provided with an outer leaf 102, which comprises a device 103 for receiving and sending mail items using an unmanned aircraft.

This device 103 for receiving and sending mail items using an unmanned aircraft preferably also again comprises the or a telescoping thrust device 105 having a landing region 104 and/or a pickup element 106, using which the landing region 104 or the pickup element 106 can be extended telescopically in the direction of the arrow out of the plane of the building or façade to provide a spaced-apart position. In this way, the outer leaf 102 of the pitched roof window element 100a can manage without a separate opening, which improves the leak-tightness of the pitched roof window element 100a.

In this case, the embodiment variants in FIGS. 7, 8, and 9 each comprise a closed outer leaf 102 without direct opening for the transport material. The opening directly in the outer leaf 102 is thus omitted. Furthermore, the respective outer leaf 102 of the respective element 100a of a window, door, pitched roof, or façade comprises circumferential seals (not shown here) similarly to a window leaf without device 103.

Moreover, a landing region 104 is provided. This can again be provided on a telescopic thrust device 105. The landing region 104 can be formed as a landing platform or as a landing framework. The landing region 104 can moreover—to avoid leak-tightness problems and to permanently protect it well against weather influences—be provided as extendable on the lower side (with respect to the folded open state) of the outer leaf 102.

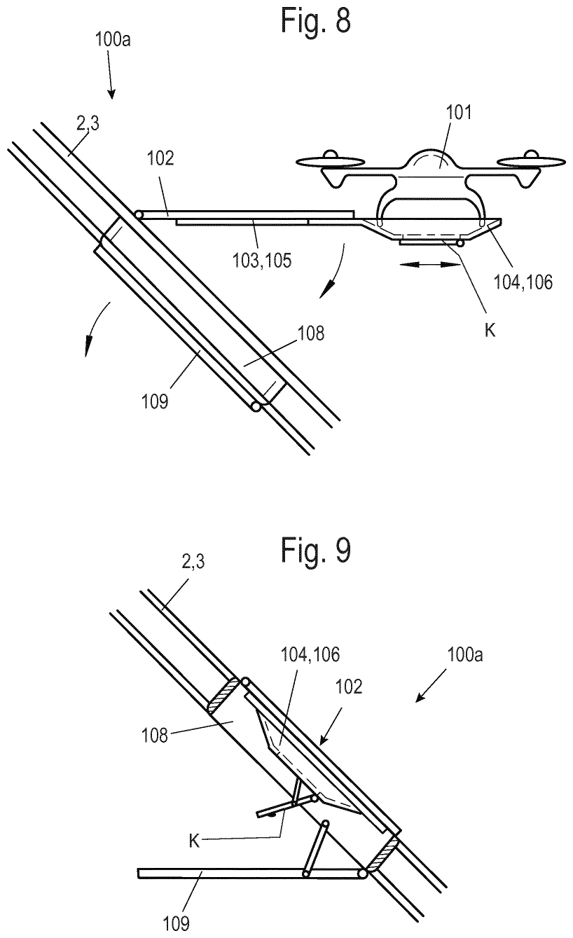

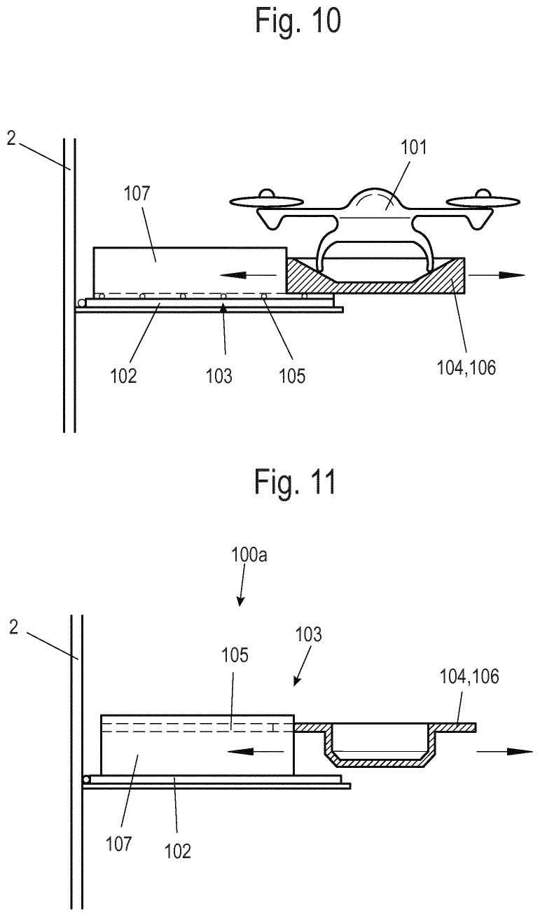

It can be formed like a type of drawer, which is preferably arranged displaceably below the outer leaf and is extendable out of the outer leaf in a horizontal position thereof (FIGS. 7, 8). It can be implemented similarly on a window element or a façade element (FIG. 10, FIG. 11). It is also conceivable to provide a pivot element instead of a thrust device to fold out the landing region. The mechanism for extending landing region can also be designed to execute a combined or overlaid linear and pivot movement.

The respective landing region 104 can comprise a respective pickup element 106 adapted to different landing frameworks of the drone 101 used, which can be formed, for example, as a type of depression in the landing region 104. In addition, the respective device 103 respectively comprises a telescopic thrust device 105. The thrust device 105 can comprise a sliding guide (see FIG. 11) or a roller guide (see FIG. 10).

In each of FIG. 7 and FIG. 10, the inside of the outer leaf 102 comprises a housing 107 for accommodating the device 103, in particular the landing region 104 and the thrust device 105. In this manner, these components are housed well protected in the retracted state and/or in the closed state of the outer leaf 102. This housing can comprise a flap K (FIG. 9), which enables a mail item to be inserted into the housing and/or to be removed therefrom. This flap K can already be considered to be the inner leaf in terms of the application. However, it is also conceivable to additionally provide a further inner leaf on the pitched roof.

In the preferred embodiment variants of the element 100a for a window, door, pitched roof, or façade element—shown first by way of example on the pitched roof element 100a for the pitched roof according to FIGS. 7, 8, and 9—the respective element 100a of a window, door, pitched roof, or façade can respectively comprise an intermediate space 108 for accommodating the housing 107 and/or the landing region 104 and/or the thrust device 105 and/or the receptacle element 106 (not shown here)—i.e., essentially the device 103.

Moreover, the intermediate space 108 can be designed and used for temporarily storing the mail items. The intermediate space 108 can also comprise the housing 107.

The intermediate space 108 comprises an inner leaf 109 in addition to the outer leaf 102. The inner leaf 109 has—similarly to the outer leaf 102—the properties of a window sash, which is to be opened to remove and/or place the transport material in the building 1.

A type of airlock is thus formed. It can be designed in such a way that advantageously in dependence on the approach or takeoff of the drone 101, only the outer leaf 102 or only the inner leaf 109 of the element 100 for a window, door, pitched roof, or façade can be opened. The airlock at least enables in a simple manner only a small amount of heat to leave or reach the building 1 during the approach or the takeoff of the drone 101, whereby the element 100a for a window, door, pitched roof, or façade element can overall have good thermal insulation properties, which can also meet elevated standards up to a passive house standard.

The inner leaf 109 can preferably also terminate flush with the inner wall of the building 1 or the inside of the façade 2. The element 100a for a window, door, pitched roof, or façade element according to the invention thus essentially has the same structural depth as the outer envelope of the building 1 or the wall of the building 1. The advantage of this inner leaf 109 is that during approach of the drone 101, when the outer leaf 102 opens, the interior of the building 1 is still secured against external influences.

In this case, the inner leaf 109 does not have to have the high requirements for thermal insulation properties, leak tightness, and break-in resistance like the outer leaf 102, since the inner leaf 109 is only briefly open for the transfer procedure of the transport material. To ensure increased break-in resistance of the element 100a for a window, door, pitched roof, or façade element, however, it can be advantageous to make the inner leaf 109 break-in resistant, since the outer leaf 102 could be able to be manipulated—with malicious intent—by the control of the drone 101. An increased break-in resistance of the element 100a for a window, door, pitched roof, or façade element thus particularly advantageously results.

The inner leaf 109 and/or the outer leaf 102 preferably each comprise a sash 113, 111. This respective sash 113, 111 preferably encloses or frames a planar element in each case. This planar element can be formed as a plate, in particular as a glass, plastic, or metal plate.

One preferred embodiment variant of an intermediate space 108 is illustrated in FIG. 12.

On the right side of FIG. 12—the building outside here—an outer window element is located having a lower frame spar shown in section of a fixed frame 110 and a sash spar of the frame 111 of the movable outer leaf 102. The outer leaf 102 may be opened outward—i.e., in respective FIG. 12 or 13 to the right—by a fitting (not shown here). An insulating glass pane is arranged in the sash 111 here.

On the left side of FIG. 12—i.e., oriented toward the interior of the building 1—a fixed frame 112 is also located in flush arrangement, which is fixedly connected to the masonry wall, and the movable inner sash 113 of the inner leaf 109 arranged therein. The sash 113 can accommodate, for example, an opaque filling plate here. It can be sufficient to design the inner leaf 109 in a simple manner. The inner leaf 109 can preferably be designed as a rotating leaf or turn-tilt leaf.

At least one plane having a seal (not shown here) is located between the sash 111 and the frame 110. Frame profiles, in particular in thermally-insulated construction, are preferably used for the frames 110, 111. The base material of the frame 111, 110 can be a metal such as steel or aluminum or also wood or plastic. Moreover, mixed forms are usable, in which the inner frame and the outer frame consist of various materials. Multiple different materials such as wood or plastic or the like are also usable in each frame.

As shown in FIG. 13, instead of two fixed frames 110, 112 for the window element 100a according to the invention, a single fixed frame 114, which is arranged between the two planes “inner leaf” and “outer leaf” and is continuous between these planes, having double stop can also be used for the inner leaf and the outer leaf.

Preferably, one, multiple, or all of the fixed frames and sashes are embodied in thermally-insulated embodiment. This means that if aluminum is preferably used from the inside to the outside on the respective frame, a multilayered structure having one or multiple aluminum profiles and at least one insulating profile plane arranged in between made of insulating profiles—in particular made of plastic—is implemented.

A type of masonry wall is illustrated by dashed lines in each of FIGS. 12 and 13 below the fixed frame or frames 110, 112, wherein it delimits a wall opening or a building opening. However, another façade element can also adjoin here in one direction or all around the frame, for example, a further element of a façade, which is designed as a mullion/post construction or a further element of an element façade, the elements of which are assembled preinstalled at the construction site like a chessboard in rows and columns, wherein these further elements preferably do not comprise a device 103.

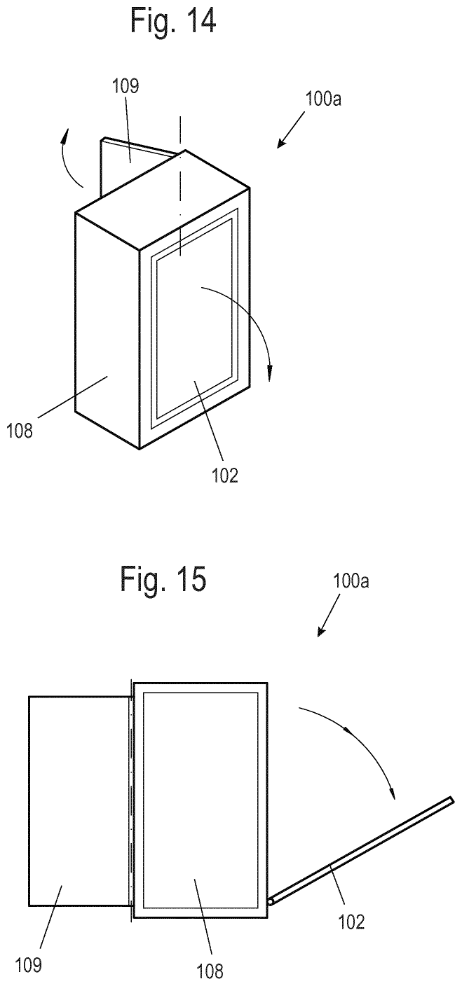

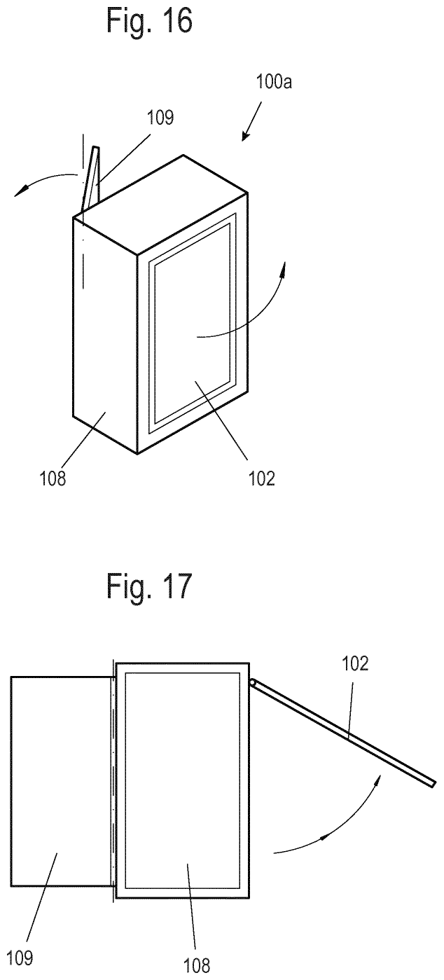

One embodiment of the window element 100a in preferred construction having an intermediate space 108 is illustrated in each of FIGS. 14 to 17. In each case the intermediate space 108 is shown having the outer leaf 102 toward the building outside and the inner leaf 109 toward the building inside. The illustrations in respective FIGS. 14 to 17 differ due to the respective opening kinematics.

FIGS. 14 and 16 or 15 and 17 each show in a three-dimensional view or in a side view, respectively, the preferred arrangement toward the building outside having an outer leaf 102 movable around a horizontal axis of rotation and toward the building inside having an inner leaf 109 movable around a vertical axis of rotation. However, other opening kinematics with the window element 100a and/or the leaves 102, 109 are also possible. These include, for example, sliding leaves, pivoting leaves, or folding leaves. The leaves 102, 109 can also be embodied in multiple parts.

The preferred window element 100a illustrated in FIGS. 14 to 17 suggests a so-called casement window in its design. The casement window or also double window systems consist of two window elements arranged at a distance to one another. Further advantages for the window element 100a result due to the embodiment as a casement window.

These include that the window element 100a can advantageously additionally be used as a ventilation element. The function as a receiving and sending station for letter and parcel shipments is not restricted in this way. The window element 100a according to the invention can accordingly additionally be equipped with ventilation channels, heat exchanger units, air filters, and sound-insulating elements. The technical utility of such a window element 100 is advantageously increased in this way.

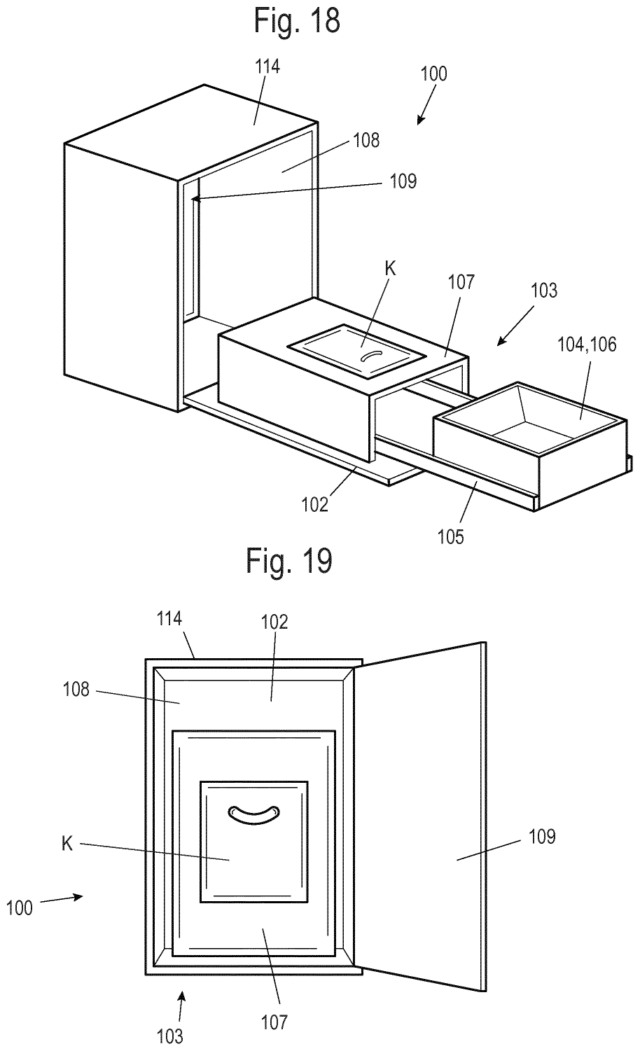

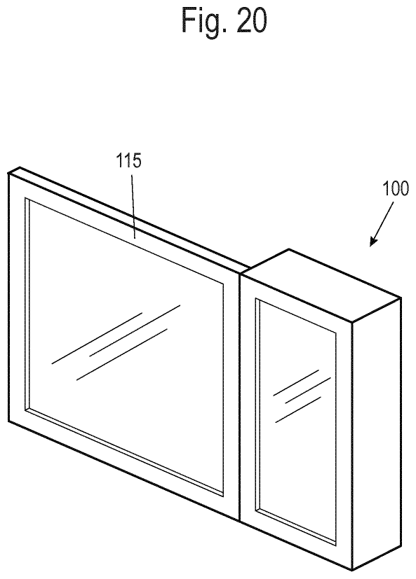

A further preferred structure of the window element 100 according to the invention is described hereafter on the basis of FIG. 18 and FIG. 19.

The intermediate space 108 is preferably formed by a continuous fixed frame 114 having double stop for the inner leaf 109 and the outer leaf 102.

The outer leaf 102 preferably rotates outward here around a horizontal axis in an opening movement. The inner leaf 109 preferably rotates around a vertical axis in an opening movement. This is preferable but not required.

The device 103 is arranged on the inner side of the outer leaf 102 and preferably comprises the housing 107. The housing 107 preferably comprises a flap K (see also FIG. 8) or door for removing or depositing the transport material. The telescoping thrust device 105 is arranged, on the one hand, on the outer leaf 102 or on the housing 107 and, on the other hand, on the landing region 104. The landing region 104 can be moved by the thrust device 105 into the housing 107. The landing region 104 can be designed as a simple surface, as a funnel-type surface, or as a pickup element 106.

The window element 100a is illustrated viewed in a front view from a room of the building in FIG. 19. The inner leaf 109 is open so that it is possible to look into the intermediate space 108 of the window element 100. The landing region 104 is retracted into the housing 107 and the outer leaf 102 is closed. To open the pickup element 106, the flap K can be opened, in order to remove a transport material or place it in the pickup element 106. The window element 100a illustrated here has a particularly large outreach, i.e., the landing region 104 is accordingly arranged far from the building 1 when the outer leaf 102 is open. Standard windows according to DIN EN 14351-1:2006-07, appendix E (window up to 2.3 m²: 1.23×1.48 m, window >2.3 m²: 1.48×2.18 m) having a sash height of 1.48 m accordingly preferably move the landing region 104 more than 1.5 m away from the building wall.

The window element 100a according to the invention can be arranged as a separate whole or as a partial segment of a larger element. One advantageous embodiment in this case is if the window element 100a is formed as a side part to a window 115 having an insulating glass pane. This is shown in FIG. 20.

However, the façade element 100a can also be inserted into the balustrade of a façade 2. It is furthermore possible to use element 100a as a side part of a door. The element 100a of a window, door, or façade according to the invention close to the ground—i.e., for example, installed in the ground floor—can theoretically also be reached by air vehicles such as drones or—where this is not permitted—served by autonomously driving transport vehicles or such land vehicles.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 building
2 façade
3 pitched roof
100 element for a window, door, pitched roof, or façade
101 drone
102 outer leaf
103 device
104 landing region
105 thrust device
106 receptacle element
107 housing
108 intermediate space
109 inner leaf
110 fixed frame
111 sash
112 fixed frame
113 sash
114 fixed frame
115 window
K flap
T transport material

1-21. (canceled)

22. An element for a window, door, pitched roof, or façade for installation in a building opening of the wall, the façade, the door, or the pitched roof, the element comprising:
a device for sending or receiving letters and parcels, wherein the device is configured so that the letters and parcels can be picked up or delivered by an unmanned air vehicle;
an outer leaf; and
an inner leaf, wherein the outer and inner leaf are separated from one another by an intermediate space.

23. The element of claim 22, wherein the intermediate space, in a closed state of the element for a window, door, pitched roof, or façade, accommodates all components of the device for receiving and sending letters or parcels.

24. The element of claim 22, wherein the intermediate space, in a element for a window, door, pitched roof, or façade, is configured to accommodate the letters or parcels.

25. The element of claim 22, wherein the intermediate space comprises a housing for accommodating the letters or parcels.

26. The element of claim 22, wherein the device for receiving and sending letters or parcels comprises a landing region configured for landing the aircraft for the letters or parcels.

27. The element of claim 26, wherein the device for receiving and sending letters or parcels comprises a pickup element for picking up or depositing the letters or parcels.

28. The element of claim 22, wherein the outer leaf and the inner leaf are aligned in parallel to one another in a closed state of the element for a window, door, pitched roof, or façade.

29. The element of claim 22, wherein the outer leaf is pivotable around a horizontal axis of rotation into a horizontal position.

30. The element of claim 22, wherein the inner leaf is rotatable or extendable in parallel in an opening movement around a vertical axis or horizontal axis or around an axis parallel to a pitched roof.

31. The element of claim 22, wherein
the outer leaf comprises a sash and a planar element,
the inner leaf comprises a sash and a surface element, and/or
one or more fixed frames are provided, on which the inner leaf and the outer leaf are movably mounted.

32. The element of claim 31, wherein one, multiple, or all of the one or more fixed frames and sashes are thermally-insulated in such a way that a multilayered structure having one or multiple aluminum profiles and at least one plastic insulating profile plane arranged in between is provided from an inside to an outside on the respective frame one, multiple, or all of the one or more fixed frames.

33. The element of claim 22, wherein the element is a pitched roof window element for a pitched roof, and the outer leaf is pivotable into a horizontal position.

34. The element of claim 27, wherein the device for receiving and sending parcels using an unmanned aircraft comprises a thrust device associated with the outer leaf, wherein the thrust device is configured so that the landing region and/or the pickup element is movable telescopically into a position spaced apart farther from the window, door, pitched roof, or façade in an extended state than in a retracted state.

35. The element of claim 22, wherein the outer leaf and the inner leaf are controlled using a control device such that they can only be opened or closed offset in time.

36. An element for a window, door, pitched roof, or façade for installation in a building opening of the wall, the façade, the door, or the pitched roof, the element comprising:
a device for sending or receiving letters and parcels, wherein the device is configured so that the letters and parcels can be picked up or delivered by an unmanned air vehicle;
an outer leaf for closing and opening a building opening;
a thrust device associated with the outer leaf, wherein the thrust device is configured so that a landing region and/or a pickup element for the letters or parcels can be moved telescopically into a position spaced apart farther from the window, door, pitched roof, or façade plane in an extended state than in a retracted state,
wherein a thrust direction of the thrust device extends in parallel to the outer leaf or an outer leaf plane.

37. The element of claim 36, wherein the outer leaf is pivotable in an installed state in a wall, façade, or in a pitched roof into a horizontal position and is lockable in this position, and the thrust direction extends horizontally.

38. The element of claim 36, the thrust device is a telescoping rail guide having multiple telescoping rails, wherein the telescoping rail guide is arranged between the landing region and/or the pickup element and the outer leaf.

39. The element of claim 37, wherein the thrust device comprises an electromotive drive.

40. A façade for a building, the façade comprising:
a plurality of façade elements, of which a part is or are formed without a device for receiving and sending parcels using an unmanned aircraft, wherein at least one of the façade elements is provided with a device for receiving and sending parcels using an unmanned aircraft, wherein an appearance of the plurality of façade elements with and without the device for receiving and sending parcels using an unmanned aircraft is identical when viewed from outside of the building.

41. The façade of claim 40, wherein the plurality of façade elements with and without device for receiving and sending parcels using an unmanned aircraft each comprise an identical outer plate of identical dimensions and/or surface composition, which is externally visible, and/or a sash appearing identical from the outside.
